(19) United States
(12) Patent Application Publication
(10) Pub. No.: US 2026/0343133 A1
(43) Pub. Date: Oct. 29, 2026

(54) EARBUDS WITH DETACHABLE EARBUD STABILIZERS

(71) Applicant: LIVV Audio Inc., Arlington, TX (US)

(72) Inventor: Mark Clayton, Fort Worth, TX (US)

(21) Appl. No.: 19/192,523

(22) Filed: Apr. 29, 2025

(51) Int. Cl. H04R 1/10

(52) U.S. Cl. CPC H04R 1/105; H04R 1/1016

(57) ABSTRACT

An earbud includes an earbud housing having a closed-end slot with a longitudinal slot axis. A detachable earbud stabilizer includes a stabilizer body having an attachment end forming an elongate slide and a free end forming a stabilizer arm. The elongate slide has a longitudinal slide axis and is slidably receivable into an open end of the closed-end slot along the longitudinal slot axis to firmly connect the detachable earbud stabilizer to the earbud housing. The stabilizer arm has a shape and orientation to securely engage an anatomical feature of a human ear when the elongate slide is fully received into the closed-end slot. In a pair of right and left earbuds, the right earbud may support interchangeable right earbud stabilizers and the left earbud may support interchangeable left earbud stabilizers. An optional kit may include both earbuds and a set of interchangeable earbud stabilizers.

### BACKGROUND

The present disclosure relates to earbud configurations having stabilizers for preventing the earbud from coming out of the ear, especially during a physical activity.

### BACKGROUND OF THE RELATED ART

An earbud is a small, rounded audio device designed to fit snugly within a person's ear canal or rest just outside it, depending on the design. Typically, an earbud has a slightly bulbous speaker portion that directs sound into a person's ear and a tapered or angled stem that extends outward or downward along the natural contour of the person's outer ear. The ergonomic shape of the earbud is crafted to align with the curves of the concha and tragus, ensuring a secure fit. Some models feature silicone tips that adapt to the unique shape of an individual person's ear canal for enhanced comfort and noise isolation. When properly positioned, the earbud sits flush against the ear, minimizing external noise interference while maintaining stability, even during movement.

The human ear has several anatomical structures that help hold an earbud securely in place. The concha, the bowl-shaped cavity leading into the ear canal, provides a natural resting spot for the main body of the earbud. The tragus, a small, rounded piece of cartilage in front of the ear canal, and the antitragus, located opposite the tragus, help provide lateral support. The helix, the curved outer rim of the ear, along with the antihelix, an inner curved ridge, further contribute to the overall shape that cradles the earbud. The ear canal (external auditory meatus) itself plays a crucial role by allowing the earbud's tip to fit snugly, creating a seal for sound isolation. Together, these structures form a natural contour that helps keep an earbud in place while also influencing the comfort and stability of the fit.

An earbud consists of several key components that work together to deliver sound and ensure a secure fit. At its core is the speaker driver, a miniature speaker that converts electrical signals into sound waves. Surrounding the driver is the housing, typically made of plastic or metal, which protects the internal components and provides structural support. The ear tip, often made of silicone or foam, fits into a person's ear canal to enhance comfort, stability, and sound isolation. Inside the housing, a rechargeable battery, usually a small lithium-ion cell, powers the earbud, enabling wireless functionality in Bluetooth models. A microphone is often embedded for voice calls and voice assistant commands. Additionally, a printed circuit board (PCB) includes various components for managing electronic signals, including audio processing, noise cancellation, and Bluetooth connectivity. Some models also feature touch sensors or buttons for playback and volume control. Together, these components create a compact, efficient audio device designed for convenience and high-quality sound performance.

Earbuds are designed with several key components that help them stay securely in place within a person's ear. The ear tip, usually made of silicone or foam, is the soft, rounded part that enters the ear canal, creating a snug seal for stability and sound isolation. Some earbuds have wing tips or ear fins which are small, curved extensions that rest against the inner contours of the ear, such as the antihelix, to provide additional grip. The earbud housing, which contains the speaker drivers and electronics, is often ergonomically shaped to fit within the concha, ensuring a secure fit without excessive pressure. Some earbuds also feature over-ear hooks which are flexible loops that wrap around the helix for added support, particularly in sports models. Together, these components work to keep the earbud in place, balancing comfort and security while optimizing audio performance.

### BRIEF SUMMARY

Some embodiments provide a modular earbud. The apparatus comprises an earbud including an earbud housing having an exterior surface and a closed-end slot, wherein the closed-end slot has a longitudinal slot axis. The apparatus further comprises a detachable earbud stabilizer having a stabilizer body, wherein the stabilizer body includes an attachment end forming an elongate slide and a free end forming a stabilizer arm. The elongate slide has a longitudinal slide axis that is slidably receivable into an open end of the closed-end slot along the longitudinal slot axis to firmly connect the detachable earbud stabilizer to the earbud housing. The stabilizer arm has a shape and orientation to securely engage an anatomical feature of a human ear when the elongate slide is fully received into the closed-end slot.

Some embodiments provide a modular earbud kit comprising left and right earbuds, each earbud including an earbud housing having an exterior surface and a closed-end slot, wherein the closed-end slot has a longitudinal slot axis and an open end that is open to the exterior surface. The kit further comprises detachable left and right earbud stabilizers of a first type and detachable left and right earbud stabilizers of a second type. Each detachable earbud stabilizer has a stabilizer body, wherein each stabilizer body includes an attachment end forming an elongate slide and a free end forming a stabilizer arm. Each elongate slide has a longitudinal slide axis that is slidably receivable into an open end of the closed-end slot along the longitudinal slot axis to firmly connect the detachable earbud stabilizer to the earbud housing, wherein each stabilizer arm has a shape and orientation to securely engage an anatomical feature of a human ear when the elongate slide is fully received into the closed-end slot.

### BRIEF DESCRIPTION OF THE SEVERAL VIEWS OF THE DRAWINGS

FIGS. 1A-B are perspective views of a pair of right and left earbuds having over-ear hooks and wing tips, respectively.

FIG. 2A is a perspective view of an earbud stabilizer having an elongate slide aligned for connecting with a closed-end slot of an earbud housing, where the earbud stabilizer is in the form of a wing tip.

FIG. 2B is a perspective of the earbud of FIG. 2A after the earbud stabilizer has been connected to the earbud housing.

FIG. 3A is a perspective view of an earbud stabilizer having an elongate slide aligned for connecting with the closed-end slot of the earbud housing, where the earbud stabilizer is in the form of a over-ear hook.

FIG. 3B is a perspective of the earbud of FIG. 3A after the earbud stabilizer has been connected to the earbud housing.

FIGS. 4A-D are various views of an earbud stabilizer having an elongate slide formed at an attachment end of the stabilizer body.

FIG. 5 is a perspective view of the earbud oriented to present a plan view of the closed-end slot.

FIG. 6A is a side view of the earbud housing and the earbud stabilizer where the elongate slide is aligned with the closed-end slot.

FIG. 6B is a side view of the earbud housing and the earbud stabilizer as in FIG. 6A after the elongate slide has been received into the closed-end slot to form a connection.

FIG. 6C is a cross-sectional view of the earbud housing and the connected earbud stabilizer taken along the line indicated in FIG. 6B.

FIGS. 7A-E are various views of a wing tip earbud stabilizer including an end view of the elongate slide (in the center) and four other views of the wing tip earbud stabilizer that are 90 degrees of rotation from the end view.

FIGS. 8A-E are various views of an over-ear hook earbud stabilizer including an end view of the elongate slide (in the center) and four other views of the wing tip earbud stabilizer that are 90 degrees of rotation from the end view.

FIGS. 9A-E are various views of an earbud housing including a first view of the earbud housing (in the center) and four other views of the earbud housing that are 90 degrees of rotation from the first view.

FIG. 10 is a diagram illustrating the components of a kit that includes a right and left earbuds, right and left wing tip earbud stabilizers, and right and left over-ear hook earbud stabilizers, wherein the right earbud stabilizers are interchangeably connectable to the right earbud and the left earbud stabilizers are interchangeably connectable to the left earbud.

FIG. 11 is a schematic diagram of an earbud housing and an earbud stabilizer having two mating slots and slides.

FIG. 12 is a block diagram of a wireless earbud configured in accordance with some embodiments.

### DETAILED DESCRIPTION

Some embodiments provide an apparatus comprising an earbud including an earbud housing having an exterior surface and a closed-end slot, wherein the closed-end slot has a longitudinal slot axis and an open end that is open to the exterior surface. The apparatus further comprises a detachable earbud stabilizer having a stabilizer body, wherein the stabilizer body includes an attachment end forming an elongate slide and a free end forming a stabilizer arm. The elongate slide has a longitudinal slide axis that is slidably receivable into an open end of the closed-end slot along the longitudinal slot axis to firmly connect the detachable earbud stabilizer to the earbud housing. The stabilizer arm has a shape and orientation to securely engage an anatomical feature of a human ear when the elongate slide is fully received into the closed-end slot.

The term “earbud” refers to a small audio device designed to fit snugly within a person's ear canal (an in-ear type earbud) or rest just outside it (an open-ear earbud), depending on the design. The earbud housing contains electronics, such as a speaker driver and a controller, for producing sound and directing the sound to the ear canal. The earbud may use short range wireless technology or wifi (i.e., eSim) for receiving wireless audio transmission from an audio source or autonomously. The earbud housing is preferably shaped or contoured to rest within or upon a person's ear in cooperation with the earbud tip (which may enter the ear canal) and/or the earbud stabilizer.

As used herein, the term “closed-end slot” refers to a slot having one closed end and one open end. Accordingly, the elongate slide is only able to be received into the slot through the open end and not through the closed end. Furthermore, the closed end of the closed-end slot may add to the structural and dimensional integrity of the slot, such as by providing greater reinforcement of the necked portion of the slot at the closed end of the slot than at the open end of the slot.

In some embodiments, the closed-end slot is a closed-end T-slot having a T-shaped internal profile, and wherein the elongate slide is a T-slide having a T-shaped external profile that is slidably receivable into the T-shaped internal profile. The internal profile of the closed-end slot refers to the shape of the space within the slot viewed as a cross-section perpendicular to the longitudinal slot axis. Conversely, the external profile of the elongate slide refers to the shape of the elongate slide viewed as a cross-section perpendicular to the longitudinal slide axis.

Referring to an internal or external profile as being T-shaped should not imply any strict notions about the exact features of the T-shape, but rather is a generality that means the profile is wider along one side than along the opposing side. Accordingly, the wider side of the elongate slide fits within the wider side of the closed-end slot and the narrower side of the elongate slide fits within the narrower side of the closed-end slot, but the wider side of the elongate slide will not pull out through the narrower side of the closed-end slot. A T-shaped profile (i.e., the crossbar) could have square or rounded corners, a curved or straight stem or crossbar, and uniform or varying widths, yet should be considered to have T-shaped profile due to its functioning as a T-shaped slot and/or T-shaped slide. Accordingly, a T-shaped profile may include a Y-shaped profile and a dovetail shaped profile. However, the internal profile of the closed-end slot and the external profile of the elongate slide are preferably complementary such that the elongate slide fits within the closed-end slot with a sufficient friction fit that the elongate slide does not accidentally come out of the open end of the closed-end slot during normal use of the earbud. Rather, the removal or disconnection of the elongate slide from the closed-end slot should require an intentional and axially directed manual force, such as by grasping the earbud stabilizer and moving it in a direction that is both parallel to the longitudinal slot axis and directed toward the open end of the closed-end of the slot.

The term “earbud stabilizer” is a general term for a component that helps to keep the earbud in place within the ear during use. Specific earbud stabilizer configurations or types include wing tips (also known as ear fins) and ear hooks. Wing tips are small, often rubbery or silicone, extensions that fit within the inner curvature of the ear in a manner that provide a more secure fit. Ear hooks are extensions that wrap around the outer part of the ear to provide a more secure fit, especially during activities like exercise.

Embodiments of the earbud stabilizer are “detachable” from the earbud housing and attachable to the earbud housing. The selective attachability and detachability of the earbud stabilizer enables the earbud to be used with or without the earbud stabilizer and enables the earbud stabilizer to be replaced. For example, a person may detach the earbud stabilizer from the earbud housing to use the earbud without the earbud stabilizer during a period of time that the person is not moving significantly, such as during a workday sitting in front of a computer. However, the person may attach the earbud stabilizer to the earbud housing to use the earbud with the earbud stabilizer during a period of time that the person is moving a lot, such as during exercise or other physical activity. Furthermore, an earbud stabilizer may be replaced due to excessive wear on an original earbud stabilizer or to use a different type, style or size of earbud stabilizer. For example, the size of the earbud stabilizer that works best for an individual person may vary according to their individual ear size and shape. Accordingly, the earbud stabilizer may be replaced with a more comfortable or suitable earbud stabilizer without having to replace the entire earbud.

In some embodiments, the open end of the closed-end slot is directed toward the ear when the earbud housing is in an operative position within the ear and the elongate slide extends away from the ear when the detachable earbud stabilizer is connected to the earbud housing. This orientation of the closed-end slot may reduce the likelihood of accidental forces dislodging the earbud stabilizer from the earbud housing (i.e., dislodging the elongate slide from the closed-end slot). Furthermore, this orientation of the closed-end slot will hide the open end of the closed-end slot in the event that a person uses the earbud without the earbud stabilizer attached.

In some embodiments, the earbud stabilizer includes a shoulder adjacent the elongate slide that meets the external surface of the earbud housing at or before a point where the tangent of the earbud housing external surface is parallel to the longitudinal axis of the closed-end slot. The shoulder is preferably designed to circumscribe the open portion of the closed-end slot and engage the external surface of the earbud housing along the entire outer edge of the shoulder. In one option, the shoulder may engage the external surface of the earbud housing at the same point that the elongate slide is fully received into the closed-end slot. In a further option, there may be surface continuity between an external surface of the stabilizer body and the external surface of the earbud housing when the elongate slide is fully received into the closed-end slot. The term “surface continuity” refers to how smoothly two or more surfaces connect. The level of surface continuity ranges from G0 to G3 according to the smoothness of the transition between surfaces. Position continuity (G0) indicates that the surfaces meet at a joint or interface but may not have smooth transitions. Tangent continuity (G1) indicates that the surfaces have the same tangent direction at the joint or interface of the two surfaces, resulting in a smoother, more continuous flow than position continuity. Curvature continuity (G2) indicates that the surfaces have the same tangent direction and curvature at the joint or interface, leading to a very smooth and natural transition. Third derivative continuity (G3) indicates that the surfaces have the same tangent direction, curvature and acceleration of curvature at the joint or interface, creating a highly polished and seamless transition.

In some embodiments, the closed-end slot includes a closed end (terminal end) opposite the open end and the elongate slide has a distal end and a proximal end. The closed-end slot may be positioned in or near an upper surface of the earbud housing when the earbud housing is oriented in an operative position for use in the ear. In one option, the closed end (terminal end) of the closed-end slot may include a flat surface that is perpendicular to the longitudinal slot axis, and the distal end of the elongate slide includes a flat surface that is perpendicular to the longitudinal slide axis of the elongate slide. Optionally, the flat surface at the distal end of the elongate slide may engage the flat surface at the closed end (terminal end) of the closed-end slot when the elongate slide is fully received into the closed-end slot.

Embodiments of the earbud housing may be made from an suitable material, such as a rigid plastic. For example, the earbud housing may be made with a blend of polycarbonate and acrylonitrile-butadiene-styrene. Independently, the detachable stabilizer may be made with rubber, such as a natural rubber or a synthetic rubber (i.e., a synthetic material with rubber-like properties. For example, the synthetic rubber may be silicone.

In some embodiments, the elongate slide is retained in the closed-end slot by a friction fit therebetween. For example, the external profile of the elongate slide may contact the internal profile of the closed-end slot at various points and/or along entire surfaces therebetween to cause friction therebetween. Optionally, the external profile of the elongate slide may be very slightly oversized or undersized relative to the internal profile of the closed-end slot, so long as the elongate slide can be manually pushed into the closed-end slot and retained under static friction. In one option, the external profile of the elongate slide is smaller than the internal profile of the closed-end slot by less than or equal to 0.1 millimeter (i.e., leaving less than a 0.1 mm gap therebetween). After the elongate slide of the earbud stabilizer has been manually pressed (forced) into the closed-end slot of the earbud housing, friction will tend to retain the elongate slide within the closed-end slot. Where the earbud stabilizer is made entirely with a rubber material, the rubber may increase the amount of friction between the elongate slide and the closed-end slot. Small, randomly directed forces as the result of the movement of a person wearing the earbud will not overcome this friction and the earbud stabilizer will remain secured to the earbud housing. An intentional and axially directed manual force, such as by grasping the earbud stabilizer and moving it in a direction that is both parallel to the longitudinal slot axis and directed toward the open end of the closed-end of the slot, is generally required to move the elongate slide within the closed-end slot as necessary to remove, disconnect or detach the earbud stabilizer from the earbud housing.

In some embodiments, the longitudinal slot axis of the closed-end slot forms an acute angle with a tangent of the external surface of the earbud housing. The acute angle formed by the longitudinal slot axis relative to the external surface means that the closed-end slot is directed into the earbud housing at a shallow angle. With the closed-end slot directed into the earbud housing at a shallow angle, the closed-end may be disposed to one side of the earbud housing and does not consume a large portion of the space within the earbud housing. In a preferred option, the closed-end slot is positioned in an upper half of the earbud housing when the earbud housing is in an operative position within the ear. Positioning the closed-end slot in the upper half of the earbud housing means that an earbud stabilizer received in the closed-end slot will be upwardly directed as is preferred for an earbud stabilizer. The remainder of the earbud housing that is not needed for the closed end slot may contain the various electronics that are necessary in order to perform the basic audio functions of an earbud plus any additional functions deemed desirable for the earbud. For example, the electronics may include a speaker driver, controller, rechargeable battery, microphone, and a Bluetooth antenna. A printed circuit board may be included to support many of these electronic and support externally accessible touch sensors or buttons for functions such as playback and volume control.

Some embodiments provide a kit comprising left and right earbuds, each earbud including an earbud housing having an exterior surface and a closed-end slot, wherein the closed-end slot has a longitudinal slot axis and an open end that is open to the exterior surface. The kit further comprises detachable left and right earbud stabilizers of a first type and detachable left and right earbud stabilizers of a second type. Each detachable earbud stabilizer has a stabilizer body, wherein each stabilizer body includes an attachment end forming an elongate slide and a free end forming a stabilizer arm. Each elongate slide has a longitudinal slide axis that is slidably receivable into an open end of the closed-end slot along the longitudinal slot axis to firmly connect the detachable earbud stabilizer to the earbud housing, wherein each stabilizer arm has a shape and orientation to securely engage an anatomical feature of a human ear when the elongate slide is fully received into the closed-end slot.

Left and right earbuds, as well as matching left and right earbud stabilizers of one type or another, may be made as enantiomorphs (mirror-images of each other) in the same manner that left and right hands are enantiomorphs, left and right feet are enantiomorphs, and left and right ears are enantiomorphs. The present disclosure discusses various features of the earbuds and earbud stabilizers that are equally applicable to both right and left earbud or both right and left earbud stabilizers. However, the disclosed features may be configured in the right earbud and right earbud stabilizers as mirror images of same features configured in the left earbud and left earbud stabilizers, or vice versa.

For example, some of the figures discussed below illustrate a right earbud and a right earbud stabilizer. It should be understood that a corresponding left earbud and left earbud stabilizer can be configured as the mirror-images or enantiomorphs of the right earbud and right earbud stabilizer, respectively. For example, if the orientation and positions (measurements) of each component or point on the right earbud and/or stabilizer are defined in a fixed three-dimensional coordinate system (x, y, x axes), a mirror plane (such as a vertical plane) can be defined beside the right earbud such that, for each point on the right earbud and/or stabilizer, there is a corresponding mirrored location on the opposite side of the mirror plane for the left earbud and/or stabilizer. The mirrored location may be calculated by inverting the coordinate component that is perpendicular to the mirror plane. For example, if the mirror plane is the y-z plane, the x-coordinate of each point (x, y, z) on the right earbud and/or stabilizer may be inverted so that the corresponding point on the left earbud is (—x, y, z).

In some embodiments of the kit, the stabilizer arm of each of the detachable left and right earbud stabilizers of the first type is configured as a wingtip that fits within the ear, and the stabilizer arm of each of the detachable left and right earbud stabilizers of the second type is configured as a hook that fits around the outer part of the ear. Optionally, a pair of left and right earbud stabilizers of another type may be included in the kit or obtained separately. Furthermore, one or more pair of left and right stabilizers of the same type but a different size may also be included in the kit or made available separately. Still further, the earbud stabilizers in a first kit may be a first size and the earbud stabilizers in a second kit may be a second size.

In some embodiments of the kit, detachable left earbud stabilizers of the first and second types may be interchangeably connectable to the left earbud but not the right earbud. Similarly, detachable right earbud stabilizers of the first and second types may be interchangeably connectable to the right earbud but not the left earbud. The lack of interchangeability of a right earbud stabilizer with a left earbud and a left earbud stabilizer with a right earbud may be implemented to prevent users from connecting the wrong combination of earbud stabilizers and earbuds. However, this lack of interchangeability of a right earbud stabilizer with a left earbud and a left earbud stabilizer with a right earbud may also be the result of the shoulder at the attachment end of the earbud stabilizer having a unique shape that only provides surface continuity with the earbud when a right earbud stabilizer is connected with a right earbud or a left earbud stabilizer is connected with a left earbud.

In some embodiments of the kit, the closed-end slot may be a closed-end T-slot having a T-shaped internal profile, and the elongate slide may be a T-slide having a T-shaped external profile that is slidably receivable into the T-shaped internal profile.

In some embodiments of the kit, for each earbud housing, the open end of the closed-end slot is directed toward the ear when the earbud housing is in an operative position within the ear and the elongate slide extends away from the ear when the detachable earbud stabilizer is connected to the earbud housing.

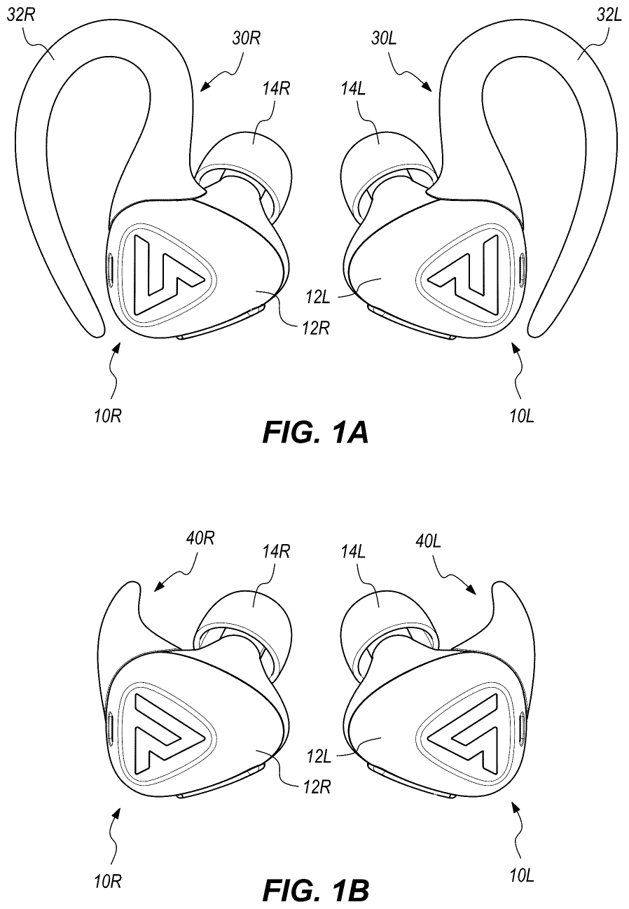

FIGS. 1A-B are perspective views of a pair of right and left earbuds having over-ear hooks (FIG. 1A) and wing tips (FIG. 1B), respectively. FIG. 1A is a perspective view of a right earbud 10R having a right over-ear hook stabilizer 30R and a left earbud 10L having a left over-ear hook stabilizer 30L. The right earbud 10R has a right earbud housing 12R that is configured for use in a person's right ear with the ear tip 14R forwardly directed into the right ear canal and the right over-ear stabilizer 30R upwardly directed so that the stabilizer arm 32R hooks around the back of the right outer ear. Similarly, the left earbud 10L has a left earbud housing 12L that is configured for use in a person's left ear with the ear tip 14L forwardly directed into the left ear canal and the left over-ear stabilizer 30L upwardly directed so that the stabilizer arm 32L hooks around the back of the left outer ear.

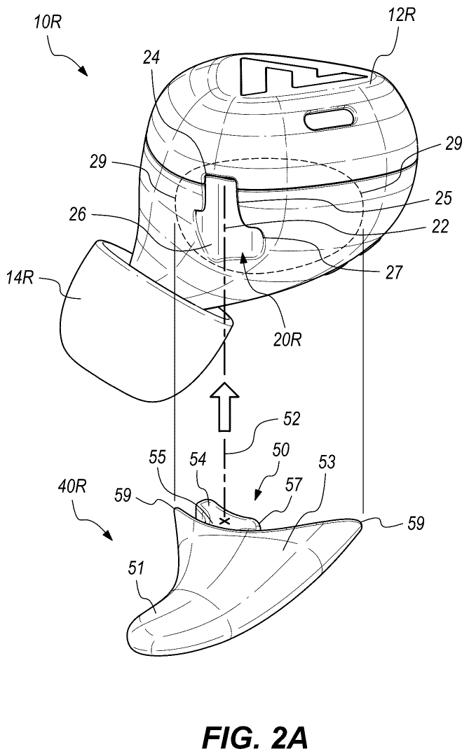

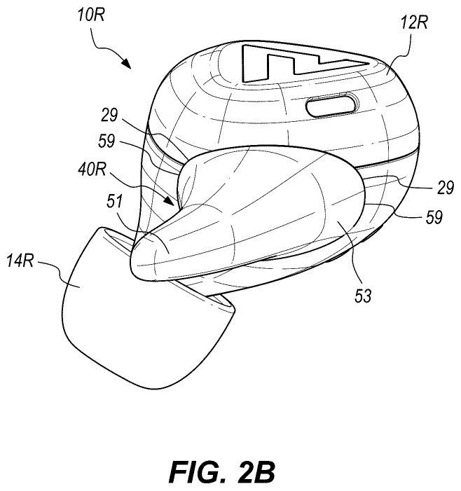

FIG. 1B is a perspective view of the right earbud 10R having a right wing tip stabilizer 40R and the left earbud 10L having a left wing tip stabilizer 40L. While the earbuds are shown with a first earbud stabilizer type in FIG. 1A and a second earbud stabilizer type in FIG. 1B, the right earbud 10R and the left earbud 10L in FIG. 1B are the same earbuds as in FIG. 1A. In other words, the right over-ear hook stabilizer 30R (FIG. 1A) has been replaced with the right wing tip stabilizer 40R (FIG. 1B) and the left over-ear hook stabilizer 30L (FIG. 1A) has been replaced with the left wing tip stabilizer 40L (FIG. 1B). It is a technical advantage of the embodiments that various earbud stabilizer types and/or sizes may be interchangeably attached/detached to right and left earbuds 10R, 10L as shown in FIGS. 1A-B. The following FIGS. 2A-B and 3A-3B show how this is accomplished.

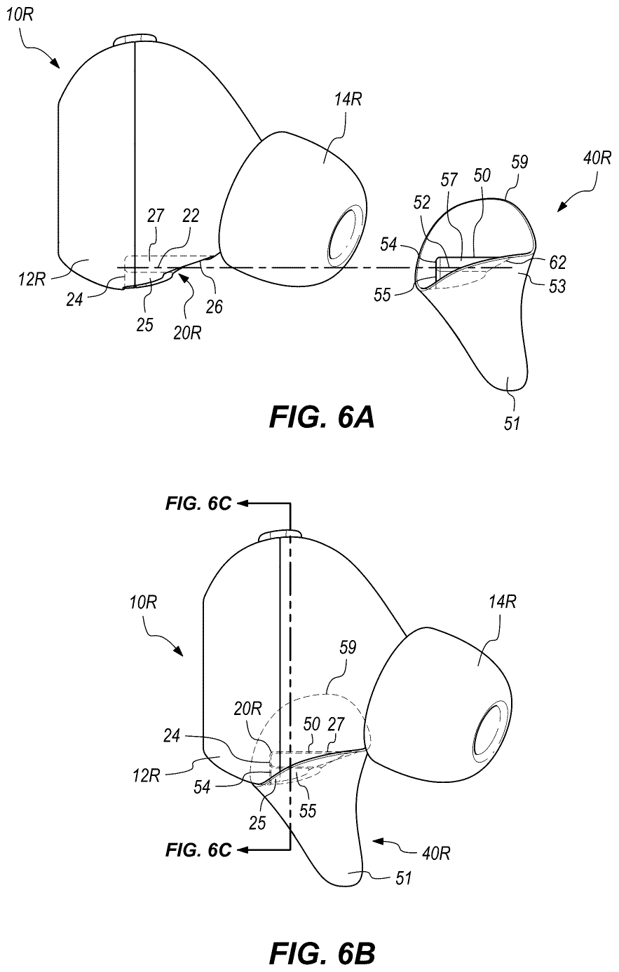

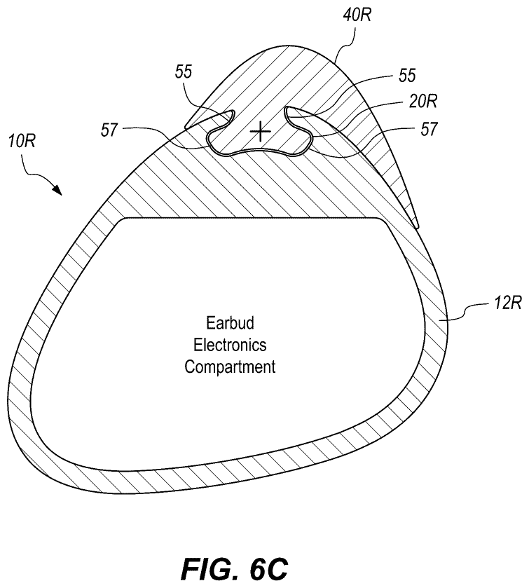

FIG. 2A is a perspective view of the right earbud 10R that has been inverted to show a top side of the right earbud housing 12R that includes a closed-end slot 20R. The closed-end slot 20R has a longitudinal slot axis 22, a T-shaped internal profile perpendicular to the longitudinal slot axis 22 (see also FIG. 6C), a closed end 24, and open end 26. The T-shaped internal profile gives the closed-end slot 20R a wide portion 27 forming the crossbar of the “T” shape and a narrow (necked) portion 25 forming the stem of the “T” shape. While the T-shaped internal profile is preferably uniform along the longitudinal slot axis 22, the longitudinal slot axis 22 is directed into the earbud housing 12R at an acute angle (see also FIG. 6A) such that the narrow portion 25 does not extend as far from the closed end 24 as does the wide portion 27. It should be appreciated that the wide portion 27 extends under the narrow portion 25 to form the “T” shape.

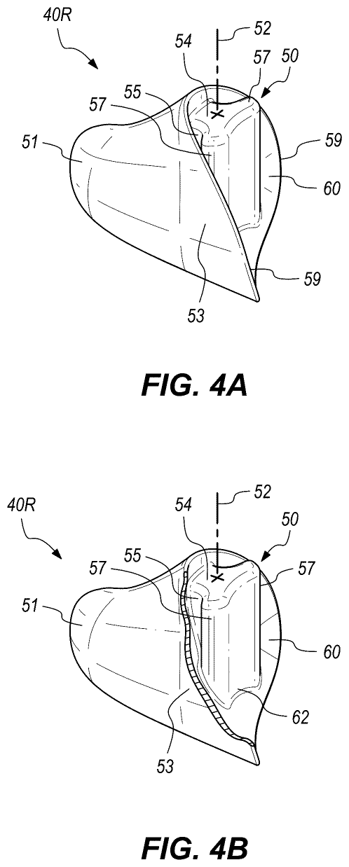

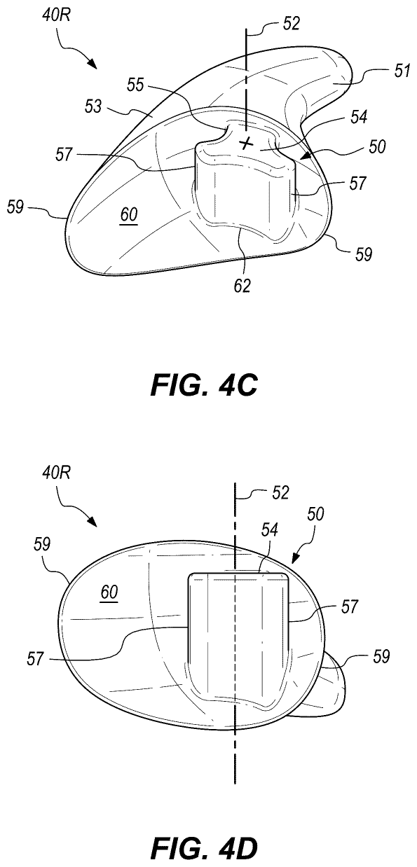

The right earbud stabilizer 40R includes an elongate slide 50 that has a longitudinal slide axis 52 and a T-shaped external profile perpendicular to the longitudinal slide axis 52. The T-shaped external profile has a wide portion 57 forming the crossbar of the “T” shape and a narrow (necked) portion 55 forming the stem of the “T” shape. Only the distal end 54 of the elongate slide 50 is visible in FIG. 2A but is shown in greater detail in FIGS. 4A-D. The longitudinal slide axis 52 of the elongate slide 50 is aligned with the longitudinal slot axis 22 of the closed-end slot 20R in preparation for connecting the earbud stabilizer 40R to the earbud housing 12R. Furthermore, the T-shaped external profile of the elongate slide 50 is oriented (rotated about the longitudinal slide axis 52) so that the wide portion 57 of the elongate slide 50 is aligned with the wide portion 27 of closed-end slot 20R and the narrow portion 55 of the elongate slide 50 is aligned with the narrow portion 25 of closed-end slot 20R.

A dashed line 29 is illustrated on the earbud housing 12R to represent the boundary about which a shoulder 59 of the earbud stabilizer 40R will engage the earbud housing 12R when the elongate slide 50 has been pressed into the closed-end slot 20R. The earbud stabilizer 40R includes an attachment end 53 that forms the shoulder 59 and secures the elongate slide 50. The earbud stabilizer 40R also has a free end 51 that forms a stabilizer arm. For the wing tip style earbud stabilizer 40R shown, the stabilizer arm is an in-ear stabilizer.

FIG. 2B is a perspective of the earbud 10R of FIG. 2A after the earbud stabilizer 40R has been attached to the earbud housing 12R. Notice that the shoulder 59 at the attachment end 53 of the earbud stabilizer 40R is flush with the surface of the earbud housing 12R along the boundary 29 (shown in dashed lines in FIG. 2A). The exterior surface contour of the earbud stabilizer 40R preferably exhibits surface continuity with those portions of the earbud housing 12R that remain exposed after attachment of the earbud stabilizer 40R. As shown in FIG. 2B, the earbud assembly formed by the combination of the earbud 10R and the earbud stabilizer 40R is ready for use. In particular, the earbud housing 12R is shaped and sized to fit in a person's right ear with the ear tip 14R directed into the right ear canal and the free end 51 of the earbud stabilizer directed along the inner contours of the right ear, such as the antihelix, to hold the earbud within the ear.

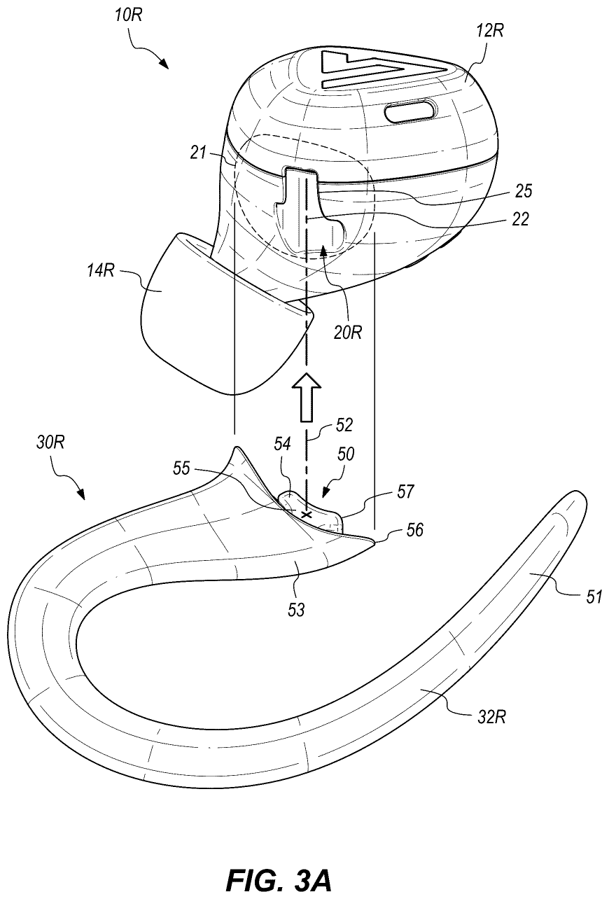

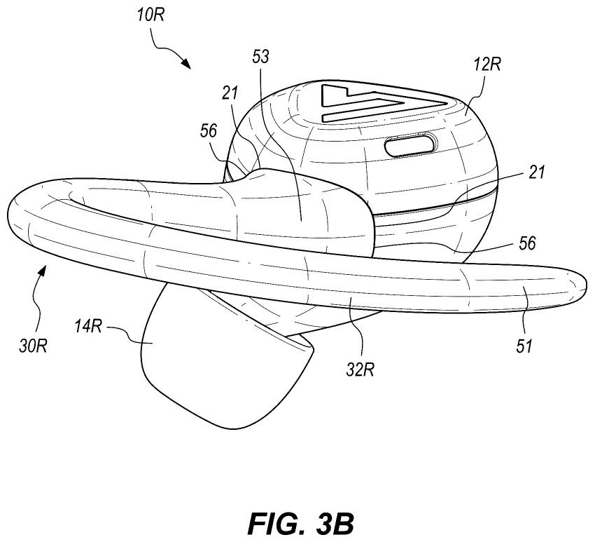

FIG. 3A is a perspective view of the right earbud 10R as shown in FIG. 2A. However, the wing tip style right earbud stabilizer 40R of FIGS. 2A-B (consistent with FIG. 1B) has been replaced with an over-ear hook style right earbud stabilizer 30R (consistent with FIG. 1A). While the wing tip and over-ear hook are different types of earbud stabilizers, embodiments may implement similar attachment features. Accordingly, components that are common to both the wing tip style right earbud stabilizer 40R and the over-ear hook style right earbud stabilizer 30R may be shown in the drawings using the same reference numbers.

The over-ear hook style right earbud stabilizer 30R includes an elongate slide 50 that has a longitudinal slide axis 52 and a T-shaped external profile perpendicular to the longitudinal slide axis 52. The T-shaped external profile has a wide portion 57 forming the crossbar of the “T” shape and a narrow (necked) portion 55 forming the stem of the “T” shape. Only the distal end 54 of the elongate slide 50 is visible in FIG. 2A but is shown in greater detail in FIGS. 4A-D. The longitudinal slide axis 52 of the elongate slide 50 is aligned with the longitudinal slot axis 22 of the closed-end slot 20R in preparation for connecting the earbud stabilizer 30R to the earbud housing 12R. Furthermore, the T-shaped external profile of the elongate slide 50 is oriented (rotated about the longitudinal slide axis 52) so that the wide portion 57 of the elongate slide 50 is aligned with the wide portion 27 of closed-end slot 20R and the narrow portion 55 of the elongate slide 50 is aligned with the narrow portion 25 of closed-end slot 20R.

A dashed line 21 is illustrated on the earbud housing 12R to represent the boundary about which a shoulder 56 of the earbud stabilizer 30R will engage the earbud housing 12R when the elongate slide 50 has been pressed into the closed-end slot 20R. The earbud stabilizer 30R includes an attachment end 53 that forms the shoulder 56 and secures the elongate slide 50. The earbud stabilizer 30R also has a free end 51 that forms a stabilizer arm. For the over-ear hook style earbud stabilizer 30R shown, the stabilizer arm is an over-ear arm 32R.

FIG. 3B is a perspective of the earbud 10R of FIG. 3A after the earbud stabilizer 30R has been attached to the earbud housing 12R. Notice that the shoulder 56 at the attachment end 53 of the earbud stabilizer 30R is flush with the surface of the earbud housing 12R along the boundary 21 (shown in dashed lines in FIG. 3A). The exterior surface contour of the earbud stabilizer 30R preferably exhibits surface continuity with those portions of the earbud housing 12R that remain exposed after attachment of the earbud stabilizer 30R. As shown in FIG. 3B, the earbud assembly formed by the combination of the earbud 10R and the earbud stabilizer 30R is ready for use. In particular, the earbud housing 12R is shaped and sized to fit in a person's right ear with the ear tip 14R directed into the right ear canal and the free end 51 of the earbud stabilizer directed over the outer part of the right ear, such as the helix, to secure the earbud to the ear.

FIGS. 4A-D are various views of the wing tip style right earbud stabilizer 40R with the elongate slide 50 formed at the attachment end 53 of the stabilizer body. FIG. 4A is a side view of the elongate slide 50 showing the narrow portion 55 (stem) connecting the wide portion 75 (crossbar) to the attachment end 53. The distal end 54 of the elongate slide 50 is visible in FIG. 4A, but a proximal end of the elongate slide 50 is hidden by the shoulder 59. The shoulder 59 has a curved edge that bounds an inner surface 60 and the elongate slide 50 extends from the inner surface 60. The contour of the inner surface, other than the elongate slide 50 itself, is preferably complementary to the contour of the earbud housing 12R surrounding the closed-end slot 20R. Accordingly, when the elongate slide 50 is fully received (seated) within the closed-end slot 20R, the inner surface 60 of the earbud stabilizer 20R may rest flush against the external surface of the earbud housing 12R in the area bounded by the dashed line 29 in FIG. 2A.

FIG. 4B is a partial cross-sectional side view of the right earbud stabilizer 40R with a portion of the shoulder 59 cut away to better show how the elongate slide 50 is formed at the attachment end 53 of the earbud stabilizer 40R. In particular, the longitudinal slide axis 52 intersects with the inner surface 60 at an angle such that the elongate slide 50 has a proximal end 62 that gradually emerges from the inner surface 60 until establishing a T-shape external profile midway between the proximal end 62 and the distal end 54. It should be appreciated that T-shaped external profile of the elongate slot 50 from the distal end 54 to the proximal end 62 may be the complement of the internal profile of the closed-end slot 20R from the closed end 24 to the open end 26.

FIG. 4C is another view (an attachment end 53 view) of the right earbud stabilizer 40R showing the elongate slide 50 gradually emerging from the inner surface 60.

FIG. 4D is yet another view (a plan view of the wide portion 57) of the right earbud stabilizer 40R showing the elongate slide 50 extending upward out of the inner surface 60.

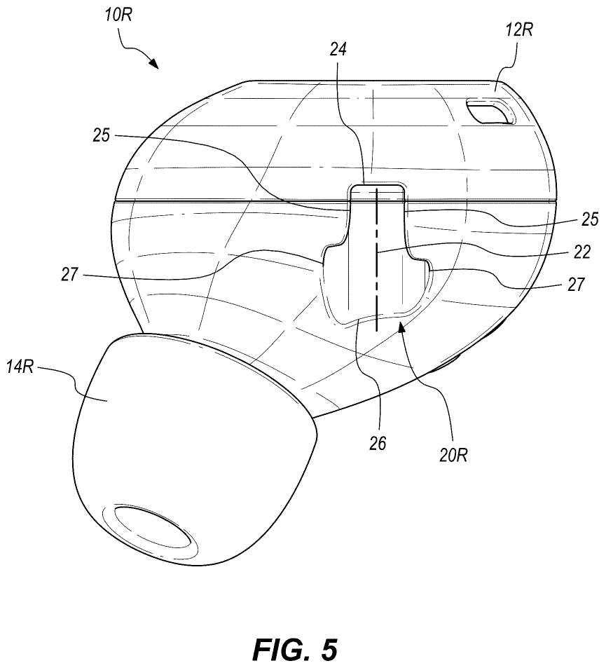

FIG. 5 is a perspective view of the right earbud 10R oriented to present a plan view of the closed-end slot 20R. Although the internal profile of the closed-end slot 20R may have a uniform profile along the longitudinal slot axis 22, such as the illustrated T-shape profile, the outline of the open end 26 as seen from this angle is affected by the contour of the earbud housing 12R.

FIG. 6A is a side view of the earbud 10R and the earbud stabilizer 40R where the longitudinal slide axis 52 and the T-shaped external profile of the elongate slide 50 are aligned with the longitudinal slot axis 22 and the T-shaped internal profile of the closed-end slot 20R. The distal end 54 of the elongate slide 50 is directed toward the closed end 24 of the closed-end slot 20R and will engage or be immediately adjacent the closed end 24 when the earbud stabilizer 40R is fully attached to the earbud 10R. In order to attach the earbud stabilizer 40R to the earbud 10R, a user must grasp the earbud stabilizer 40R and press the elongate slide 50 into the closed-end slot 20R in the leftward direction as illustrated in FIG. 6A.

FIG. 6B is a side view of the earbud 10R and the earbud stabilizer 40R as in FIG. 6A after the elongate slide 50 has been received into the closed-end slot 20R to form a connection. Accordingly, the distal end 54 of the elongate slide 50 is immediately adjacent the closed end 24 of the closed-end slot 20R. Also note that the surfaces of the wide portion 57 of the elongate slide 50 contact the surfaces of the wide portion 27 of the closed-end slot 20R. Furthermore, the narrow portion 25 of the closed-end slot 20R has received the narrow portion 55 of the elongate slide 50 and prevents the elongate slide from pulling out of the slot in an upward direction. The earbud stabilizer 40R is secured to the earbud 10R by the friction fit between the elongate slide 50 and the closed-end slot 20R and does not come free during normal use. In order to remove the earbud stabilizer 40R from the earbud 10R, the user would grasp the earbud stabilizer 40R and forcibly move the earbud stabilizer 40R in the rightward direction as illustrated in FIG. 6B to overcome the friction fit and move the elongate slide 50 out of the closed-end slot 20R.

FIG. 6C is a cross-sectional view of the earbud housing 12R and the attached earbud stabilizer 40R taken along the line indicated in FIG. 6B. The wide portion 57 and narrow portion 55 of the T-shape profile of the elongate slide 50 are shown received (seated) in the wide portion 27 and narrow portion 25 of the closed-end slot 20R, respectively. Any gap between the surfaces of the elongate slide 50 and the closed-end slot 20R is preferably less than or equal to about 0.1 millimeter. Accordingly, there will be significant surface engagement between the elongate slide 50 and the closed-end slot 20R and side-to-side or twisting forces applied to the earbud stabilizer 40R and/or the earbud housing 12R will just increase the amount of friction that keeps the two components attached unless the user intentional applies a force along the longitudinal axis 22, 52 to overcome the frictional force and move the elongate slide 50 out of the closed-end slot 20R. Also note that the closed-end slot 20R is positioned along the upper portion of the earbud 10R such that a substantial portion of the space within the earbud housing 12R is still available for containing the electronics that support the audio and other functionality of the earbud 10R.

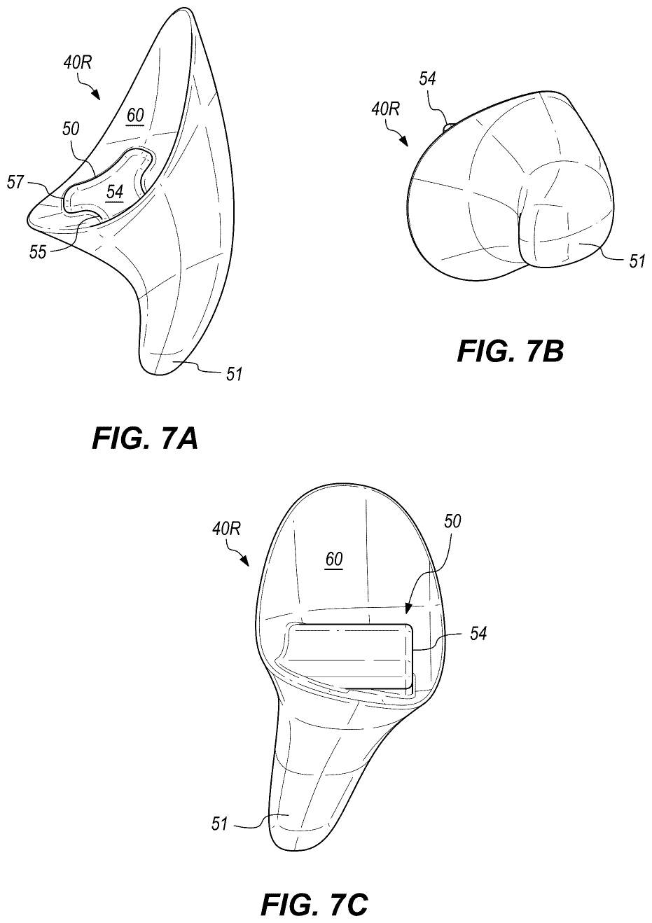

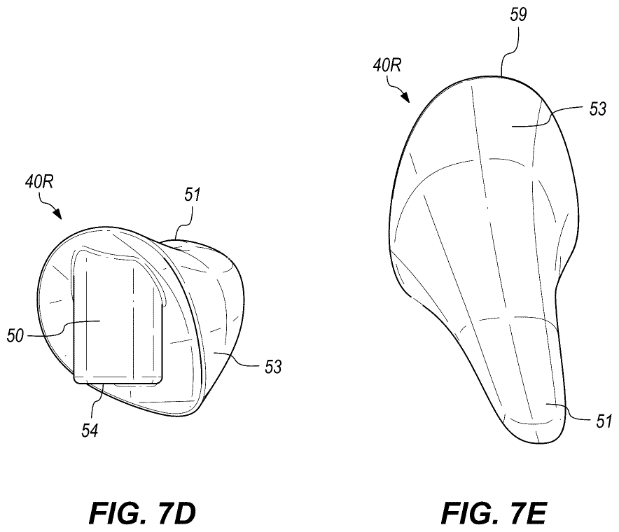

FIGS. 7A-E are various views of the wing tip earbud stabilizer 40R. FIG. 7A illustrates the earbud stabilizer 40R from an angle that provides an end view of the elongate slide 50. FIG. 7B is a view of the earbud stabilizer 40R after a 90-degree upward rotation about a horizontal line from view in FIG. 7A. FIG. 7C is a view of the earbud stabilizer 40R after a 90-degree rightward rotation about a vertical line from view in FIG. 7A. FIG. 7D is a view of the earbud stabilizer 40R after a 90-degree downward rotation about a horizontal line from view in FIG. 7A. FIG. 7E is a view of the earbud stabilizer 40R after a 90-degree leftward rotation about a vertical line from view in FIG. 7A.

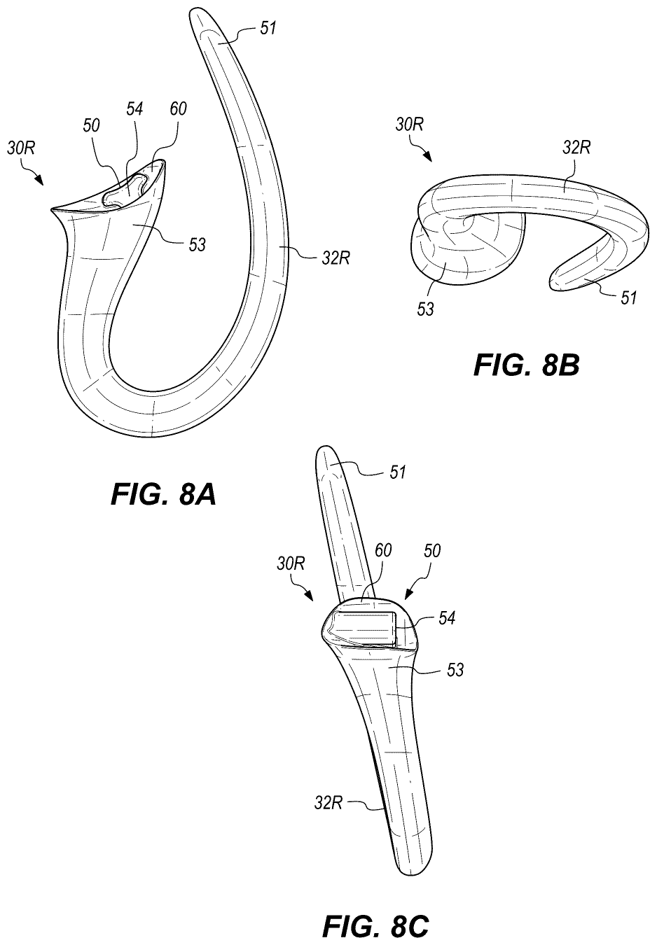

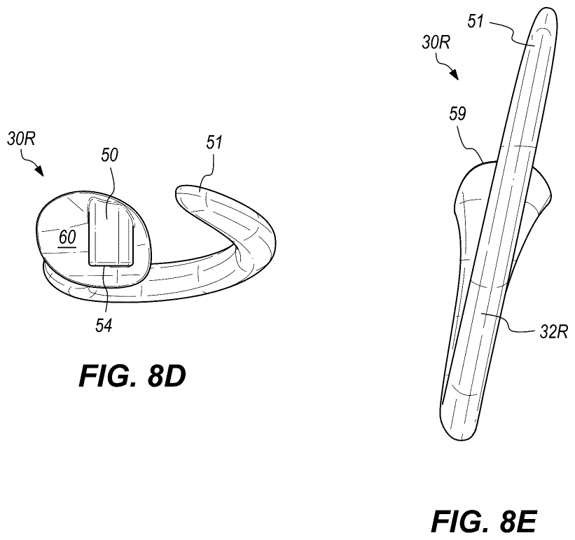

FIGS. 8A-E are various views of the over-ear hook earbud stabilizer 30R. FIG. 8A illustrates the earbud stabilizer 30R from an angle that provides an end view of the elongate slide 50. FIG. 8B is a view of the earbud stabilizer 30R after a 90-degree upward rotation about a horizontal line from view in FIG. 8A. FIG. 8C is a view of the earbud stabilizer 30R after a 90-degree rightward rotation about a vertical line from view in FIG. 8A. FIG. 8D is a view of the earbud stabilizer 30R after a 90-degree downward rotation about a horizontal line from view in FIG. 8A. FIG. 8E is a view of the earbud stabilizer 30R after a 90-degree leftward rotation about a vertical line from view in FIG. 8A.

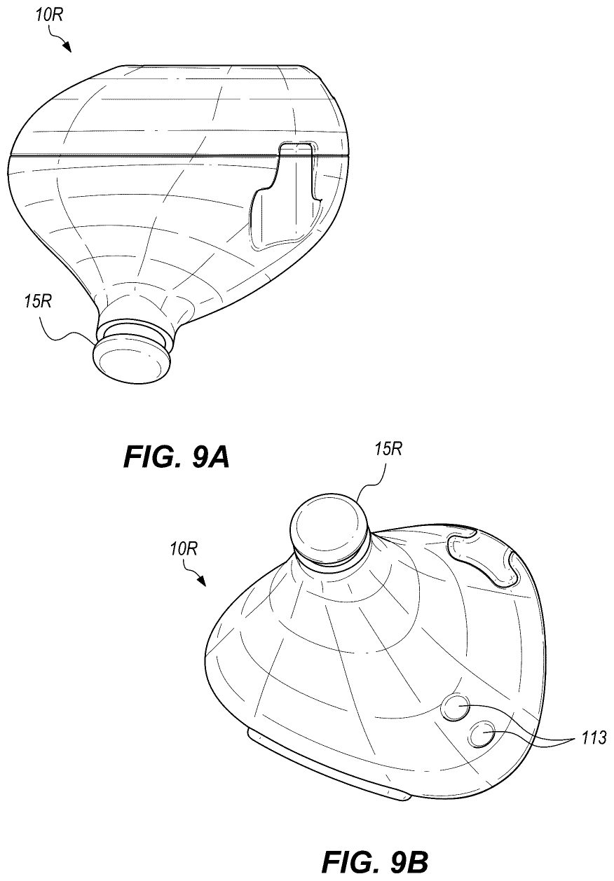

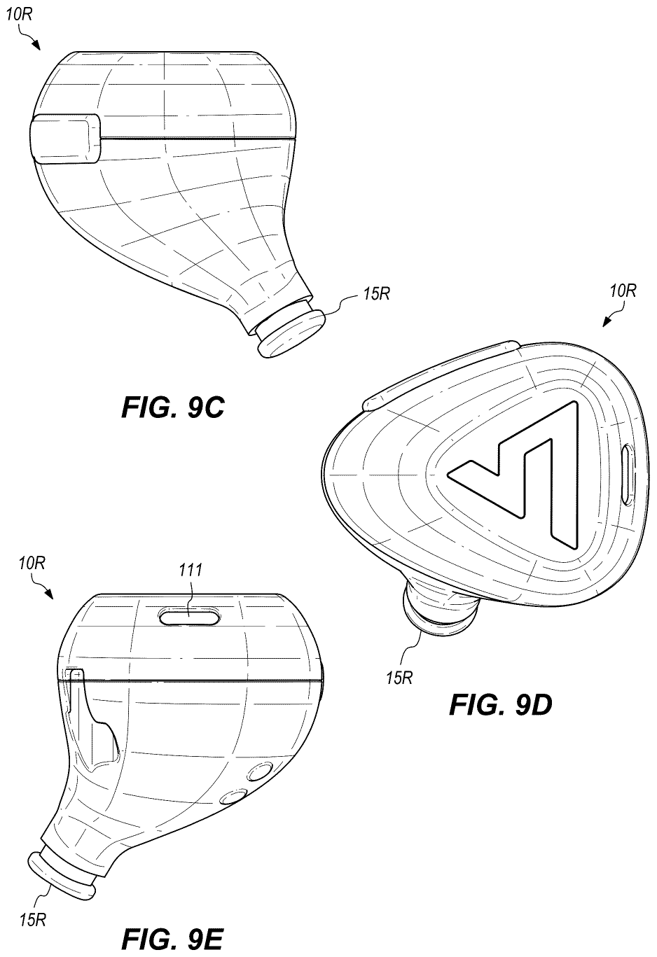

FIGS. 9A-E are various views of the earbud 10R with the soft earbud tip 14R (see FIG. 2A) removed and revealing an underlying structural ear tip 15R. FIG. 9A illustrates the earbud 10R from an angle that provides an end view of the elongate slide 50. FIG. 9B is a view of the earbud 10R after a 90-degree upward rotation about a horizontal line from view in FIG. 9A. FIG. 9C is a view of the earbud 10R after a 90-degree rightward rotation about a vertical line from view in FIG. 9A. FIG. 9D is a view of the earbud 10R after a 90-degree downward rotation about a horizontal line from view in FIG. 9A. FIG. 9E is a view of the earbud 10R after a 90-degree leftward rotation about a vertical line from view in FIG. 9A.

Embodiments of the earbud 10R may include one or more buttons for controlling power (on/off), audio production (volume up/down, pause/play/repeat), or other functionality (answer phone, mute microphone, etc.). Any such buttons may be arranged in any position or configuration. One optional button style and position is illustrated as button 111 in FIG. 9E. Other optional buttons, sensors or charging pads 113 are illustrated in FIG. 9B. Other control features may be included without limitation.

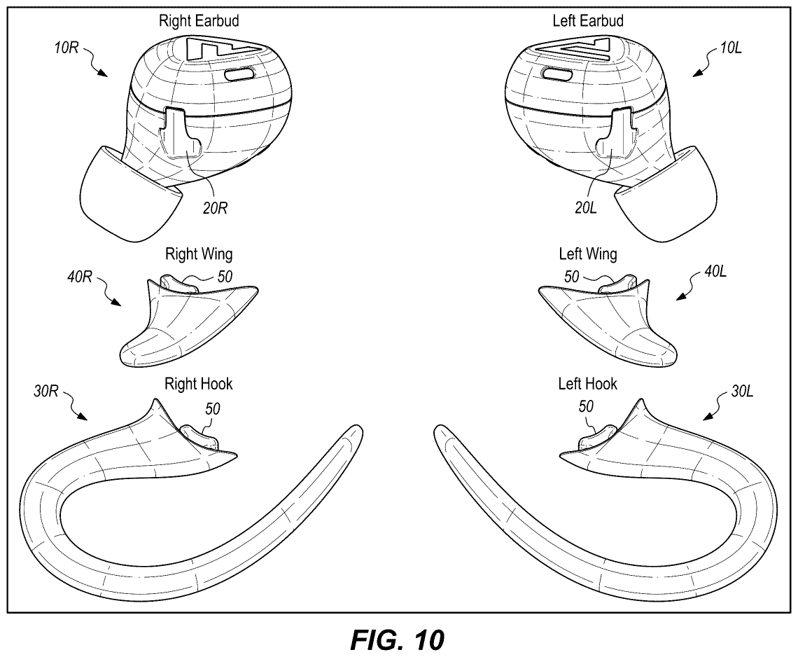

FIG. 10 is a diagram illustrating the components of a kit that includes right and left earbuds 10R, 10L, right and left wing tip earbud stabilizers 40R, 40L, and right and left over-ear hook earbud stabilizers 30R, 30L, wherein the right earbud stabilizers 40R, 30R are interchangeably connectable to the right earbud 10R and the left earbud stabilizers 40L, 30L are interchangeably connectable to the left earbud 10L. Earbud stabilizers of other types and/or other sizes or materials may be included in a kit.

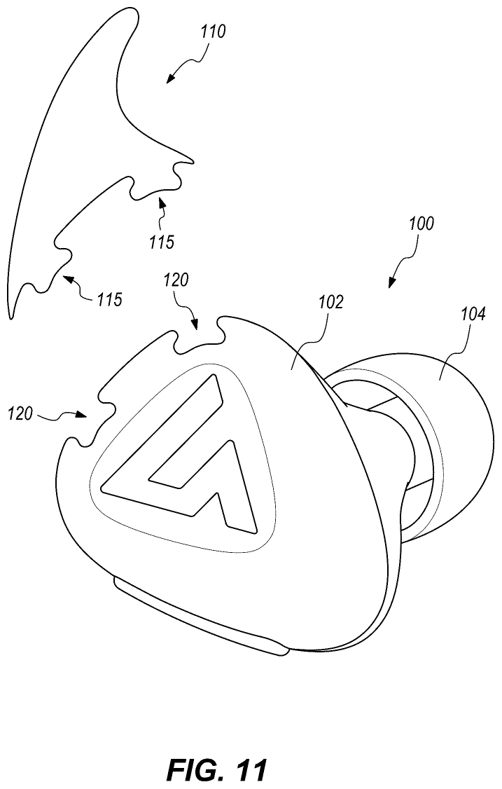

FIG. 11 is a schematic diagram of an earbud 100 having an earbud housing 102 and an earbud tip 104. The earbud housing 102 includes multiple slots 120, which may be configured and used in the same manner as the closed-end slot 20R described herein in the context of single slot embodiments. Furthermore, an earbud stabilizer 110 has multiple elongate slides 115. In particular, the number of elongate slides 115 should match the number of slots 120 and each elongate slide 115 should be spaced and configured to align with one of the slots 120.

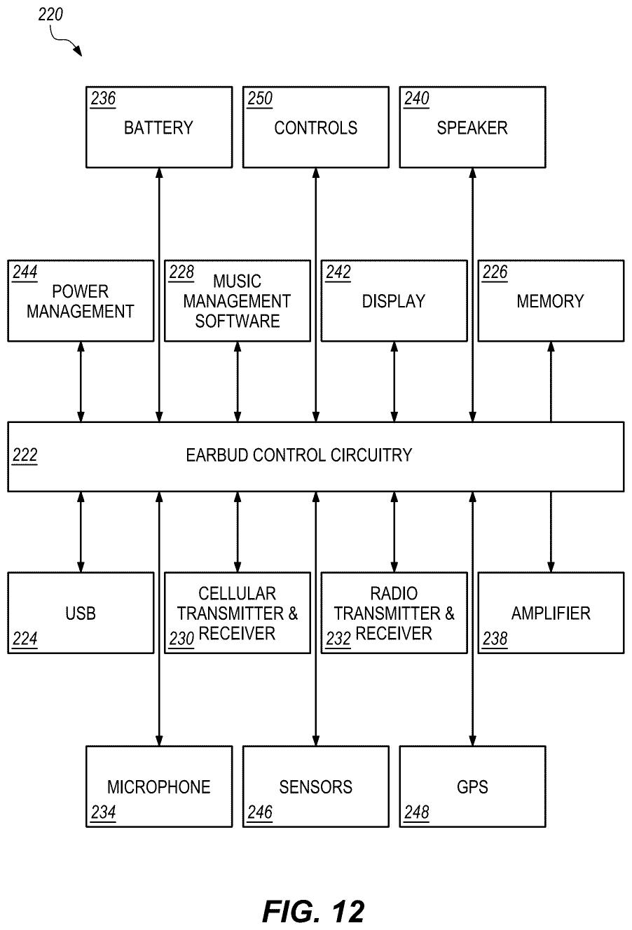

FIG. 12 is a block diagram of a wireless earbud 220 configured in accordance with some embodiments. The wireless earbud 220 includes earbud control circuitry 222 that is connected either wirelessly or via a wired electric lead to a number of different components each capable of providing unique and redundant electronic capabilities. As shown, a Universal Serial Bus (USB) port 224 can be provided to allow the control circuitry 222 to connect to an external power source and/or computing device. The USB port 224 can be used to upload, download, and update files and software resident in volatile and non-volatile memory 226 resident in the earbud 220. For example, the USB port 224 may be used to download music management software 228 to the memory 226 that allows audio files to be wirelessly downloaded over cellular 230 and radio 232 transmission means, perhaps in response to voice commands recognized by a microphone 234.

The music management software 228, regardless of how it was downloaded to the earbud(s) 220, may subsequently play audio files by manipulating power from at least one battery 236 to an amplifier 238 and a speaker 240 to reproduce audio signals recognizable by the user. Such audio reproduction may correspond with the playing of music, engaging in a cellular or radio conversation, and/or entering verbal commands through the microphone, that may be aided by an optional display 242 that can be seen external to the earbud 220 and projected to be viewed by a user while the earbud 220 is being worn.

The earbud control circuitry 222 may employ power management logic or device 244 and circuitry that can maximize performance and endurance of the earbud 220 by adjusting the active status of various software and hardware components. For instance, the power management logic 244 may sense inactivity in the cellular transmitter 230 or that the earbud 220 is not being worn from proximity and/or temperature sensors 246 to engage in minimizing power delivery to some or all of the control circuitry 222. The addition of various different types of sensors 246 can complement a GPS 248 element to allow the earbud 220 to track and store physical data pertaining to a user, such as distance traveled, calories burned, balance, and geo-positional locations visited, which may be downloaded or utilized by software to provide advertising, user knowledge, and situational statistics. The control circuitry 222 may further provide wired and wireless controls that can correspond to internal and external software programs

The terminology used herein is for the purpose of describing particular embodiments only and is not intended to limit the scope of the claims. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the embodiment.

The corresponding structures, materials, acts, and equivalents of all means or steps plus function elements in the claims below are intended to include any structure, material, or act for performing the function in combination with other claimed elements as specifically claimed. Embodiments have been presented for purposes of illustration and description, but it is not intended to be exhaustive or limited to the embodiments in the form disclosed. Many modifications and variations will be apparent to those of ordinary skill in the art after reading this disclosure. The disclosed embodiments were chosen and described as non-limiting examples to enable others of ordinary skill in the art to understand these embodiments and other embodiments involving modifications suited to a particular implementation.

What is claimed is:

1. An apparatus, comprising:
an earbud including an earbud housing having an exterior surface and a closed-end slot, wherein the closed-end slot has a longitudinal slot axis and an open end that is open to the exterior surface;
a detachable earbud stabilizer having a stabilizer body, wherein the stabilizer body includes an attachment end forming an elongate slide and a free end forming a stabilizer arm, wherein the elongate slide has a longitudinal slide axis that is slidably receivable into an open end of the closed-end slot along the longitudinal slot axis to firmly connect the detachable earbud stabilizer to the earbud housing, and wherein the stabilizer arm has a shape and orientation to securely engage an anatomical feature of a human ear when the elongate slide is fully received into the closed-end slot.

2. The apparatus of claim 1, wherein the closed-end slot is a closed-end T-slot having a T-shaped internal profile, and wherein the elongate slide is a T-slide having a T-shaped external profile that is slidably receivable into the T-shaped internal profile.

3. The apparatus of claim 1, wherein the open end of the closed-end slot is directed toward the ear when the earbud housing is in an operative position within the ear and the elongate slide extends away from the ear when the detachable stabilizer is connected to the earbud housing.

4. The apparatus of claim 1, wherein the earbud stabilizer includes a shoulder adjacent the elongate slide that meets the external surface of the earbud housing at or before a point where the tangent of the earbud housing external surface is parallel to the longitudinal axis of the closed-end slot.

5. The apparatus of claim 4, wherein the shoulder engages the external surface of the earbud housing when the elongate slide is fully received into the closed-end slot.

6. The apparatus of claim 5, wherein there is surface continuity between an external surface of the stabilizer body and the external surface of the earbud housing when the elongate slide is fully received into the closed-end slot.

7. The apparatus of claim 1, wherein the closed-end slot has a terminal end opposite of the open end, and wherein the elongate slide has a distal end and a proximal end.

8. The apparatus of claim 7, wherein the closed-end slot is positioned in an upper surface of the earbud housing when the earbud housing is oriented in an operative position for use in the ear.

9. The apparatus of claim 7, wherein the terminal end of the closed-end slot includes a flat surface that is perpendicular to the longitudinal slot axis, wherein the distal end of the elongate slide includes a flat surface that is perpendicular to the longitudinal slide axis of the elongate slide, and wherein the flat surface at the distal end of the elongate slide engages the flat surface at the terminal end of the closed-end slot when the elongate slide is fully received into the closed-end slot.

10. The apparatus of claim 6, wherein the earbud housing is made with a blend of polycarbonate and acrylonitrile-butadiene-styrene, and wherein the detachable stabilizer is made with rubber.

11. The apparatus of claim 1, wherein the elongate slide is retained in the closed-end slot by a friction fit therebetween.

12. The apparatus of claim 1, wherein the stabilizer arm is configured as a wingtip that fits within the ear or a hook that fits around the outer part of the ear.

13. The apparatus of claim 1, wherein the earbud includes an extended tip receivable into an ear canal of the ear.

14. The apparatus of claim 1, wherein the earbud uses short range wireless technology for wireless audio transmission between the earbud and an audio source.

15. The apparatus of claim 1, wherein the longitudinal slot axis of the closed-end slot forms an acute angle with a tangent of the external surface of the earbud housing.

16. A kit comprising:
left and right earbuds, each earbud including an earbud housing having an exterior surface and a closed-end slot, wherein the closed-end slot has a longitudinal slot axis and an open end that is open to the exterior surface;
detachable left and right earbud stabilizers of a first type; and
detachable left and right earbud stabilizers of a second type, wherein each detachable earbud stabilizer has a stabilizer body, wherein each stabilizer body includes an attachment end forming an elongate slide and a free end forming a stabilizer arm, wherein each elongate slide has a longitudinal slide axis that is slidably receivable into an open end of the closed-end slot along the longitudinal slot axis to firmly connect the detachable earbud stabilizer to the earbud housing, and wherein each stabilizer arm has a shape and orientation to securely engage an anatomical feature of a human ear when the elongate slide is fully received into the closed-end slot.

17. The kit of claim 16, wherein the stabilizer arm of each of the detachable left and right earbud stabilizers of the first type is configured as a wingtip that fits within the ear, and wherein the stabilizer arm of each of the detachable left and right earbud stabilizers of the second type is configured as a hook that fits around the outer part of the ear.

18. The kit of claim 16, wherein the detachable left earbud stabilizers of the first and second types are interchangeably connectable to the left earbud but not the right earbud, and wherein the detachable right earbud stabilizers of the first and second types are interchangeably connectable to the right earbud but not the left earbud.

19. The kit of claim 16, wherein the closed-end slot is a closed-end T-slot having a T-shaped internal profile, and wherein the elongate slide is a T-slide having a T-shaped external profile that is slidably receivable into the T-shaped internal profile.

20. The kit of claim 16, wherein, for each earbud housing, the open end of the closed-end slot is directed toward the ear when the earbud housing is in an operative position within the ear and the elongate slide extends away from the ear when the detachable earbud stabilizer is connected to the earbud housing.
